(19) United States
(12) Patent Application Publication
(10) Pub. No.: US 2010/0307424 A1
(43) Pub. Date: Dec. 9, 2010

(54) Pet accessory

(76) Inventor: Ronald G. Evans, Carthage, MO (US)

Correspondence Address: LITMAN LAW OFFICES, LTD., PATENT LAW BUILDING, 8955 CENTER STREET, MANASSAS, VA, 20110, US

(21) Appl. No.: 12/801,155

(22) Filed: May 25, 2010

Related U.S. Application Data
(60) Provisional application No. 61/213,421, filed on Jun. 5, 2009.

(51) Int. Cl. A01K 29/00; A01K 1/00

(52) U.S. Cl. 119/416; 119/165

(57) ABSTRACT

The pet accessory is configurable as either a pet bed or litter box. The base comprises a semi-open enclosure having a closed floor and open top for use as a pet bed when appropriate bedding is installed therein, or as a litter box when pet litter is placed therein. A mat or tray is placed immediately outside the entrance and exit when the accessory is used as a litter box, to capture litter tracked by the pet. An intermediate ventilated cover rests atop the lower enclosure, serving as a tray for holding pet accessories. Finally, a raised lid having a ventilated top panel is placed atop the intermediate cover or tray. An odor filter may be installed with the top panel, in certain embodiments. The accessory may have the appearance of a large decorative pottery vessel or other structure (box, trunk, cabinet, etc.), permitting its placement anywhere in the home.

### CROSS-REFERENCE TO RELATED APPLICATION

This application claims the benefit of U.S. Provisional Patent Application Ser. No. 61/213,421, filed Jun. 5, 2009.

### BACKGROUND OF THE INVENTION

1. Field of the Invention

The present invention relates generally to articles and accessories providing for the care and comfort of house pets, and more particularly to a pet accessory that may be used as a litter box or as a pet bed, but has an external appearance simulating a different article or structure.

2. Description of the Related Art

Innumerable pet accessories have been developed in the past to serve a vast number of different purposes in the care of household pets. Specialized articles serving as pet beds are well known, with such articles generally having an open configuration and clearly indicating their function by their appearance.

Many species of pets, particularly cats, but also including ferrets, rabbits, and other species on occasion, can readily be trained to use a litter box placed in some particular area of the home. Most such litter boxes are also relatively functional in their appearance, with it being obvious even to the most casual observer, as to what the litter box is. This does not pose a significant problem in many households, where the litter box may be located in a laundry room or similar area of the home that guests do not generally visit. However, smaller homes such as many apartments and condominiums often have limited interior space, with common utility areas being provided outside the private living areas. This greatly limits the options for the owner of a pet when it comes to locating a litter box or the like in an unobtrusive area. Oftentimes, the pet owner has no choice but to locate the litter box in a corner of the living room or other area typically visited by guests, where the litter box is in plain sight to all.

Thus, a pet accessory solving the aforementioned problems is desired.

### SUMMARY OF THE INVENTION

The pet accessory comprises a semi-enclosed structure that may be adapted for use as either a pet bed or litter box for pets, depending upon how it is configured or furnished by the pet owner. The accessory may include three or four different components, depending upon its intended use. A lowermost component comprises a mat or tray for placement immediately outside the entrance and exit to the accessory. This mat or tray is specially configured to dislodge litter from the paws of pets exiting the device when it is used as a litter box. The next component comprises the main housing or enclosure, and has a pet entrance and exit formed in one side, a closed bottom or floor, and an open top. Bedding may be installed within this enclosure if it is to be used as a pet bed, or pet litter may be placed therein for use as a litter box.

A central component comprises a ventilated cover for the top of the main enclosure, and also serves as a tray for the storage of various pet accessories (litter scoop, dust pan and whisk broom, paper towels, plastic trash bags, disinfectant or deodorant, etc.). An upper cover or lid is placed atop this central component to conceal the various accessories that might be stored therein. The upper cover has an open lower area providing clearance for accessories stored on the central component or tray, and a ventilated upper panel. In at least one embodiment, the upper panel may be used to hold an odor filter of activated charcoal or other material, if desired.

In at least one embodiment, the general configuration of the pet accessory when assembled may resemble a large decorative pottery, earthenware jar, or the like. The appearance of such a device allows the device to be placed in virtually any area of the home where it is viewed as a decorative article, rather than as a functional device for the containment of pet litter and the like. Alternatively, the pet accessory may be constructed in the form of a rectangular box or the like to provide a more economical device. Such a rectangular configuration may be decorated or embellished to have an appearance resembling a large trunk, cabinet, or similar device, if so desired. In all embodiments, the lower mat or tray and the entrance to the lower enclosure may be oriented toward a corner of the room, where they are not readily visible to persons elsewhere in the room. This also benefits the pet, as many pets (particularly cats) tend to be shy about their elimination habits and do not wish to be observed in the act. Thus, the pet will more readily use the pet accessory when configured as a litter box, even though it may be placed in a highly visible area.

However, it will be recognized that the pet accessory need not be limited to use as a litterbox or pet bed. The device may also be used for the storage of various pet-related articles, e.g., toys, leashes, etc., or even for non-pet related functions or storage, if desired. The multiple levels of space within the device, as provided by the larger lower container and the cover or tray that installs removably thereon, provide a means for storing innumerable household articles.

These and other features of the present invention will become readily apparent upon further review of the following specification and drawings.

### BRIEF DESCRIPTION OF THE DRAWINGS

FIG. 1 is an environmental, perspective view of a first embodiment of a pet accessory according to the present invention.

FIG. 2 is an exploded perspective view of the pet accessory of FIG. 1, illustrating its various components and their relationship to one another.

FIG. 3 is a side elevation view in section of the pet accessory of FIGS. 1 and 2, showing various internal details thereof.

FIG. 4 is an exploded perspective view of a second embodiment of a pet accessory according to the present invention, configured as a rectangular box or the like.

FIG. 5 is a detail elevation view in section of the pet accessory of FIG. 4, showing assembly of the intermediate storage tray on the top of the lower structure and the lid overlying the storage tray and top of the lower structure.

Similar reference characters denote corresponding features consistently throughout the attached drawings.

### DETAILED DESCRIPTION OF THE PREFERRED EMBODIMENTS

The present invention relates to a pet accessory that is adaptable for use as either a pet bed when appropriate bedding materials are installed therein, or as a litter box when pet litter is placed therein. The accessory comprises a plurality of components, which, when assembled, may have the appearance of a decorative household article to allow the pet accessory to be placed unobtrusively in an area of the home subject to visits by guests.

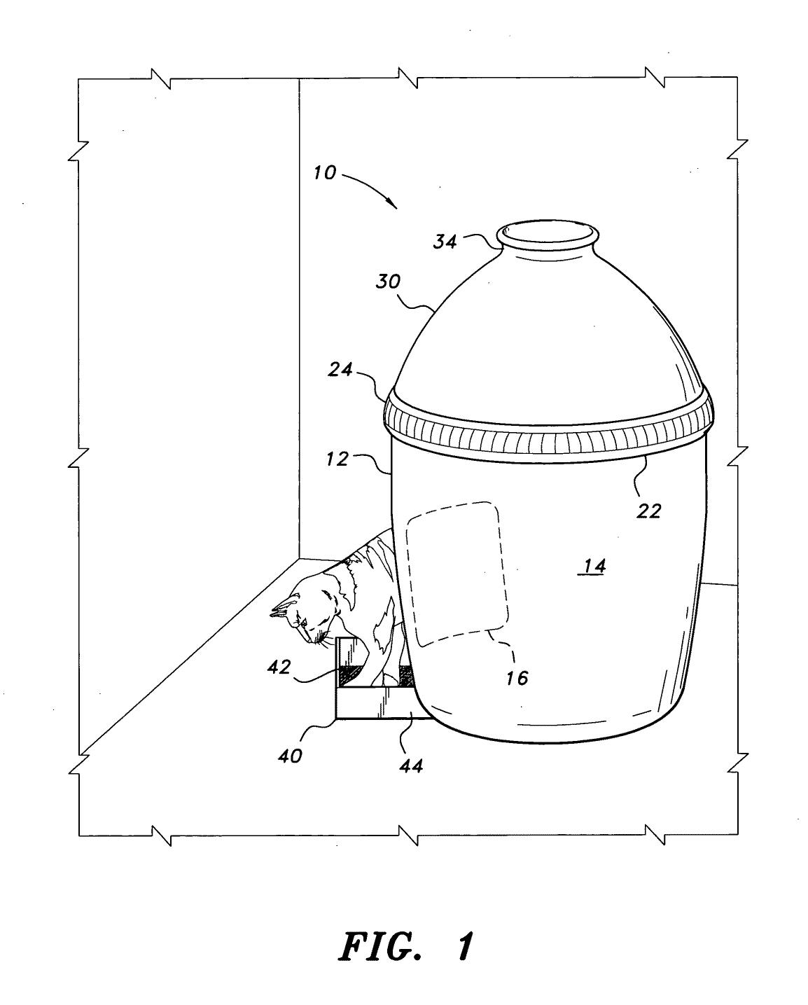

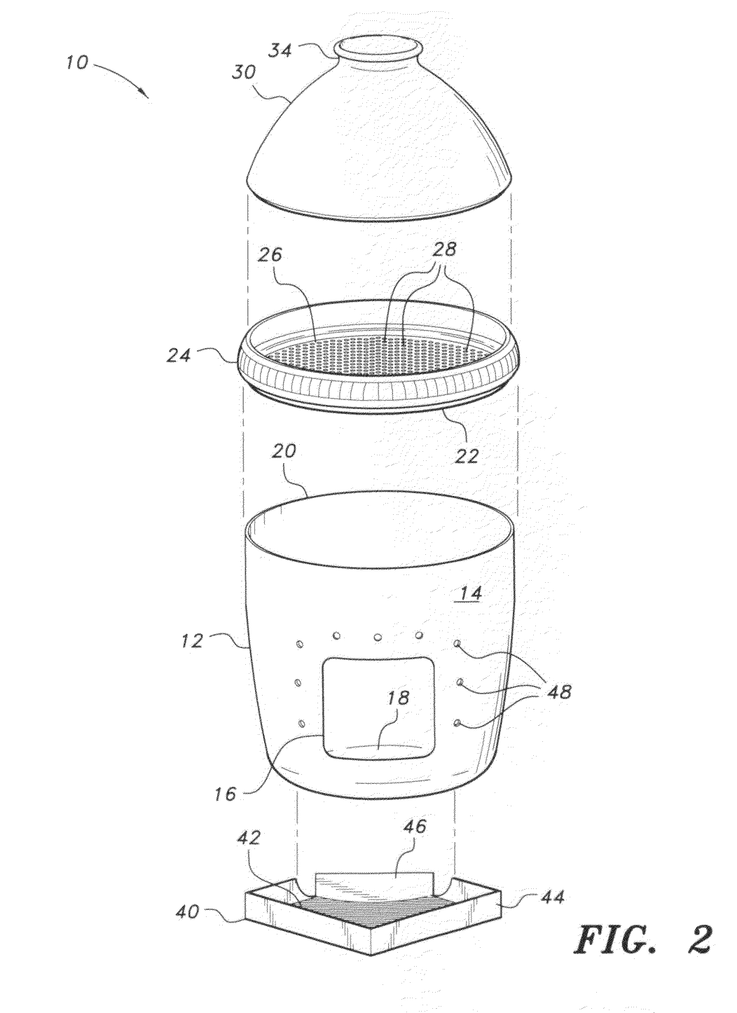

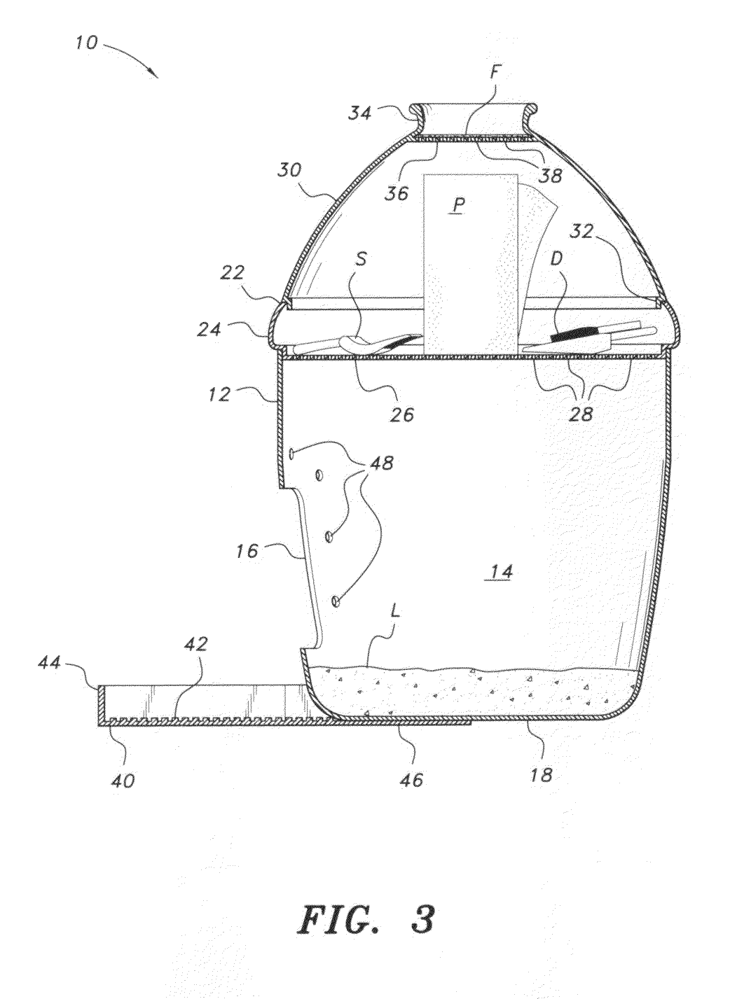

FIG. 1 of the drawings provides an environmental perspective view of a first embodiment of the pet accessory, designated as pet accessory 10, illustrating an exemplary installation and use. The pet accessory 10 comprises a lower enclosure 12 having a sidewall 14 with a pet access opening 16 formed therethrough, a closed floor 18 (shown most clearly in the elevation view in section of FIG. 3), and an open top 20 (shown in FIG. 2). The pet accessory 10 is preferably configured to have the appearance of a decorative household article, e.g., a large pottery vessel or the like, when completely assembled. The owner of the accessory 10 may orient the pet access opening 16 of the lower enclosure 12 toward a wall or corner, thus concealing the function of the device to visiting guests.

An intermediate storage tray 22 having a diameter slightly greater than the open top 20 of the lower enclosure 12 is configured for removable placement atop the lower enclosure 12. The storage tray 22 includes a rim 24, preferably having a decorative appearance that extends outwardly slightly beyond the periphery of the open top 20 of the lower enclosure 12 when the storage tray 22 is placed thereon. The protruding rim 24 serves as a handgrip to allow the owner to lift the tray 22 easily from the lower enclosure portion 12 of the accessory. The storage tray 22 further includes a floor or shelf 26 having a plurality of ventilation passages 28 formed therethrough, as shown most clearly in FIG. 2 of the drawings. This allows the storage tray 22 to hold or support various articles thereon, e.g., a litter scoop S, paper towels P, a dust pan and whisk broom D, and/or other cleanup or maintenance articles or equipment, as shown in the elevation view in section of FIG. 3. This storage tray 22 may be used for the storage of various pet toys, treats, brushes, etc., in lieu of the articles noted above, when the pet accessory 10 is used as a pet bed or the like. The floor or shelf 26 may be reinforced with lateral ribs or stiffeners therebeneath in order to support a greater load, if desired.

A lid or cover 30 is removably installed atop the rim 24 of the storage tray 22, and preferably has sufficient height to provide clearance for the various cleanup and maintenance articles that might be stored on the floor or shelf 26 of the storage tray 22. The cover 30 completes the decorative appearance of the assembled pet accessory 10. The lid or cover 30 includes a depending circumferential flange 32 that seats within the upper edge of the rim 24 of the storage tray 22, as shown in FIG. 3, and extends upwardly to a smaller diameter neck 34. The neck 34 includes a panel 36 extending thereacross (shown in the elevation view in section of FIG. 3). The panel 36 includes a plurality of ventilation passages 38 formed therethrough, in much the same manner as the ventilation passages 28 formed through the floor or shelf 26 of the intermediate storage tray 22. The ventilated panel 36 of the lid or cover 30 may serve to hold or support an odor filter element F thereon, as shown in the elevation view in section of FIG. 3, e.g., a sheet of activated charcoal material or other suitable deodorizing material.

It is well known that pets, and particularly cats, tend to track grains of litter from their litter box after use. Accordingly, the pet accessory 10 may include a litter trap 40 for placement immediately adjacent the pet access opening 16 of the lower enclosure portion 12, and external to that opening 16. The pet using the accessory 10 as a litter box thus steps into and on the litter trap 40. The trap 40 has a textured floor surface 42 adapted or configured, to spread the pads or toes of the pet to cause grains of litter to fall therefrom. The texture may be a ribbed pattern, as shown, or other pattern (small raised bumps, etc.), so long as the pattern produces the desired effect.

A raised peripheral wall 44 extends about the majority of the textured floor surface 42, serving as additional means to retain litter tracked from the lower enclosure 12. The wall 44 is open along the portion of the litter trap 40 that abuts the lower enclosure 12 when the trap 40 is used therewith. A relatively thin, flat retaining flange 46 extends from the litter trap 40, substantially coplanar with the floor surface 42. This retaining flange 46 extends from the edge of the floor surface 42 that is open, i.e., not having the wall 44 extending upwardly therefrom, and serves to secure the litter trap 40 to the remainder of the structure of the pet accessory 10. The litter trap retaining flange 46 is placed beneath the floor 18 of the lower enclosure 12 with the pet access opening 16 oriented toward the litter trap 40, thereby requiring any animals exiting the enclosure 12 to walk across the textured floor surface 42 of the litter trap 40. The weight of the assembled pet accessory 10 resting upon the litter trap retaining flange 46 is sufficient to hold the litter trap in place, particularly when several pounds (or more) of pet litter L is placed in the bottom of the lower enclosure 12, as shown in FIG. 3 of the drawings.

While it is understood that the pet accessory 10 may be used as a pet bed if appropriate bedding is placed within the lower enclosure 12, the various drawings illustrate the pet accessory 10 being used as a litter box, as evidenced particularly by FIG. 3, with the pet litter L shown in the bottom of the lower enclosure 12. Accordingly, a plurality of additional ventilation passages 48 may be installed through the wall 14 of the lower enclosure, if desired. Such additional ventilation passages 48 are preferably located near the access opening 16 in order to be turned toward the wall or other concealing structure for the opening 16 when the pet accessory is so oriented, generally as shown in FIG. 1 of the drawings. In this manner, the unbroken surface of the remainder of the assembled pet accessory 10 provides the desired appearance of a decorative article. However, such additional ventilation passages 48 may be distributed as desired over any portion of the wall 14 of the lower enclosure 12, as desired.

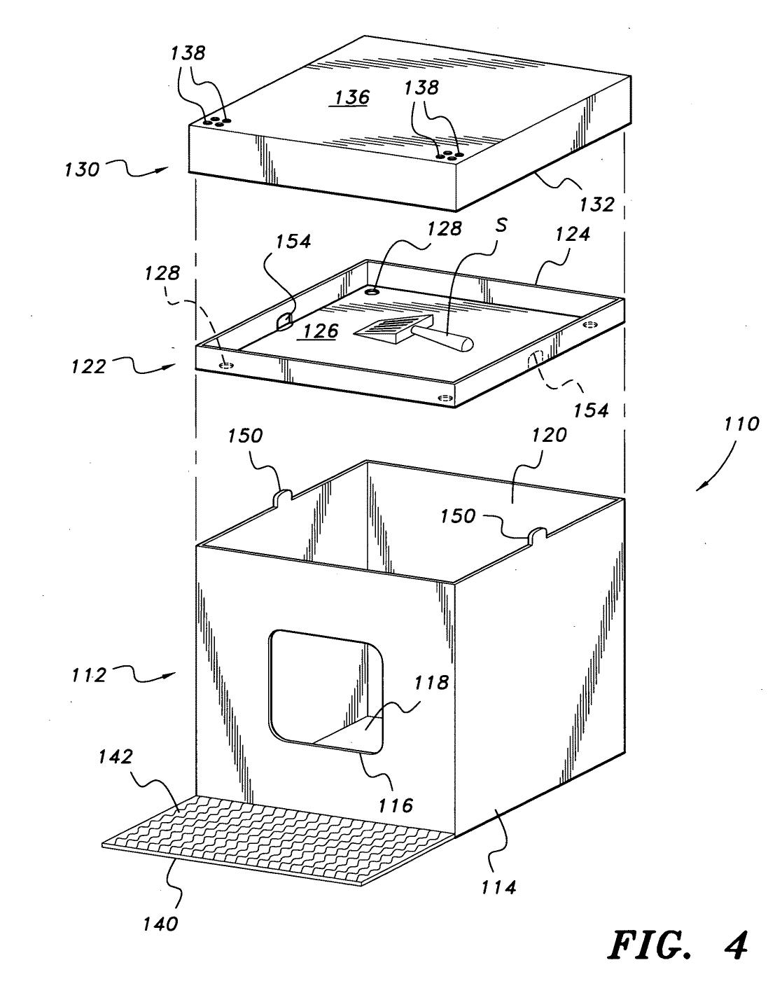

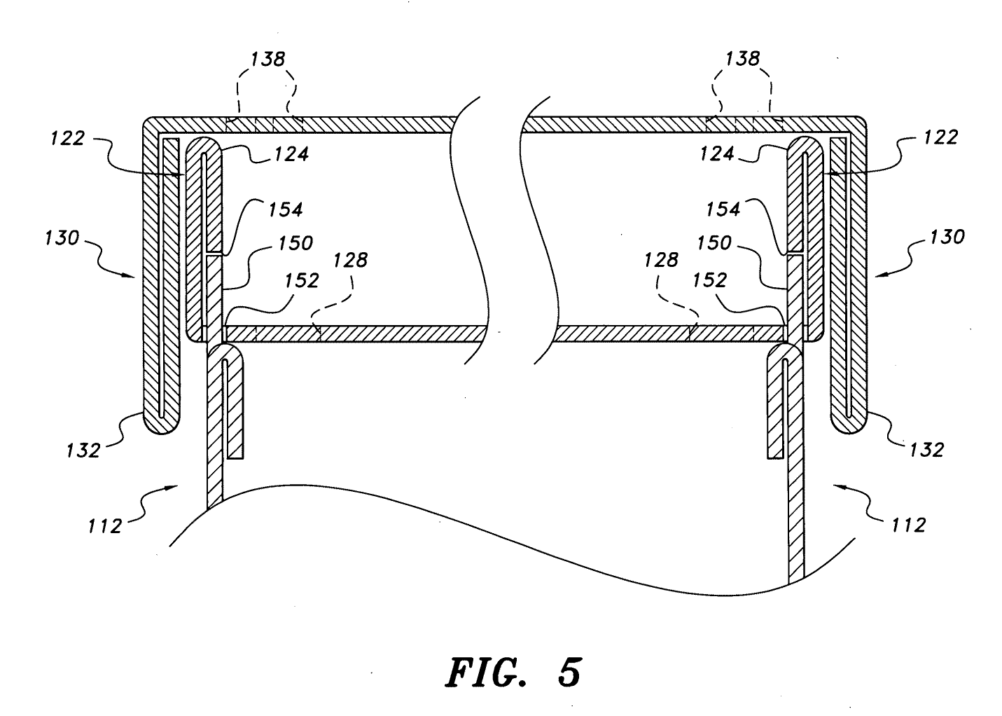

FIG. 4 of the drawings illustrates a second embodiment of the pet accessory, designated as pet accessory 110, with FIG. 5 illustrating further details of the pet accessory 110. The pet accessory 110 incorporates all of the essential features described further above for the pet accessory 10 of FIGS. 1-3, but has a less ornamental appearance and configuration to provide a more economical construction. The flat, planar surfaces of the pet accessory 110 allow it to be constructed of a relatively few sheets of flat stock material, e.g., heavy gauge corrugated cardboard stock (such material may be provided with moisture resistance for greater durability), corrugated plastic sheet material, etc., as desired. The pet accessory 110 may be prefabricated, with the retailer or purchaser of the device folding the panels as designated to complete the device. While the pet accessory 110 is illustrated as an unadorned box-like structure, it will be seen that it may be made to resemble other structures (e.g., a trunk, enclosed end table, storage cube, etc.) as desired, with little additional effort and expense.

The pet accessory 110 comprises a substantially rectangular lower enclosure 112 having a sidewall 114 formed of four panels, with one of the panels having a pet access opening 116 formed therethrough. The lower enclosure 112 is completed with a closed floor 118 and an open top 120. The owner of the accessory 110 may orient the pet access opening 116 of the lower enclosure 112 toward a wall or corner to conceal the function of the device to visiting guests, as in the pet accessory embodiment 10 of FIGS. 1 through 3. Additional ventilation holes or passages may be formed through the wall 114, somewhat similar the ventilation passages 48 shown in FIGS. 2 and 3 for the pet accessory 10.

An intermediate storage tray 122 having a width essentially identical to the open top 120 of the lower enclosure 112 is configured for removable placement atop the lower enclosure 112. The storage tray 22 includes a rim or perimeter wall 124 that is essentially coplanar with the periphery of the open top 120 of the lower enclosure 112 when the storage tray 122 is placed thereon. The upwardly extending periphery 124 serves as a handgrip to allow the owner to lift the tray 122 easily from the lower enclosure portion 112 of the accessory 110. The storage tray 122 further includes a floor or shelf 126 having a plurality of ventilation passages 128 formed therethrough, preferably in the corners of the floor or shelf 126. This allows the storage tray 122 to hold or support various articles thereon, e.g., a litter scoop S, paper towels P, dust pan and whisk broom D, and/or other cleanup or maintenance articles or equipment, as shown in the elevation view in section of FIG. 3. This storage tray 122 may be used for the storage of various pet toys, treats, brushes, etc., in lieu of the articles noted above, when the pet accessory 110 is used as a pet bed or the like. The floor or shelf 126 may be reinforced with lateral ribs or stiffeners therebeneath in order to support a greater load, if so desired, and the upstanding rim or periphery 124 may be taller to provide room for larger or bulkier accessories, e.g., paper towels, cleaning supplies, etc.

A lid or cover 130 is removably installed atop the rim 124 of the storage tray 122. The lid or cover 130 includes a depending peripheral flange 132 of slightly greater dimensions than the upstanding wall 114 of the lower enclosure 112 and the rim or wall 124 of the intermediate storage tray 122. In this manner, the depending flange 132 of the lid or cover 130 can fit over both the rim or wall 124 of the intermediate storage tray 122 and the upper edge of the wall 114 of the lower enclosure 112 to hold the intermediate storage tray 122 in registry with the lower enclosure 112. The upper panel 136 may include a plurality of ventilation passages 138 formed therethrough, in much the same manner as the ventilation passages 128 formed through the floor or shelf 126 of the intermediate storage tray 122.

The pet accessory 110 may include a litter trap 140 for placement immediately adjacent the pet access opening 116 of the lower enclosure portion 112, and external to that opening 116, as in the case of the embodiment of FIGS. 1 through 3. The trap 140 may have a textured floor surface 142 (e.g., ribbed, small bumps, etc.) adapted or configured to spread the pads or toes of the pet to cause grains of litter to fall therefrom, as in the case of the litter trap 40 of the earlier described embodiment. The litter trap 140 of the embodiment 110 of FIG. 1 may also include a raised peripheral wall, as in the embodiment of FIGS. 1 through 3, if desired. A relatively thin, flat retaining flange (not shown) extends from the litter trap 140 to be secured beneath the lower enclosure 112, the weight of the pet accessory 110 holding the retaining flange in place as in the litter trap 40 and its retaining flange 46 of the pet accessory 10 of FIGS. 1 through 3.

FIG. 5 illustrates details of the construction and assembly of the intermediate storage tray 122 and the lid or cover 130 on the top of the lower enclosure 112 for the pet accessory 110. The pet accessory 110 may be manufactured much more economically than the pet accessory 10 of FIGS. 1 through 3. The pet accessory 110 may be constructed of flat sheet material having at least some rigidity. The sheet material may comprise one or more plies of corrugated cardboard, corrugated plastic sheet, or even sheet metal. The common point between all of these materials is that they may be bent or folded to form a three-dimensional structure from their essentially two-dimensional sheet initial state. The various openings (ventilation passages, slots and tabs, etc.) may be stamped or otherwise formed into the flat sheets at the time of manufacture. Alternatively, such a pet accessory 110 could be constructed of wood or molded plastic.

The lower enclosure 112 is folded to form a box-like structure, as shown in FIG. 4. The upper edges may be folded inwardly, with the folded inner ply of material terminating immediately below the upper edge or continuing to a point lower within the enclosure 112. In any event, two mutually opposed tabs 150 are stamped or otherwise cut from the inwardly folded material, immediately adjacent the upper edge of the enclosure 112. These tabs 150 protrude upwardly from the upper edge, and engage corresponding slots 152 stamped or cut into the periphery of the floor or shelf 126 of the intermediate storage tray 122, immediately adjacent the upwardly extending rim or wall 124. A corresponding relief 154 may be removed from any downwardly and inwardly turned material comprising the rim or wall 124 to clear the two tabs 150. This structure assists in the retention of the intermediate storage tray 122 resting in registry upon the upper edge of the lower enclosure 112 until the lid or cover 130 is installed to provide additional security, as described below.

The intermediate storage tray 122 has substantially the same outer dimensions as the lower enclosure 112, i.e., the outer wall 124 of the storage tray 122 will be substantially coplanar with the walls 114 of the lower enclosure 112 when the tray 122 is placed thereon. There may be some slight misalignment due to the thickness of the sheet material of which these components are formed, but it will only be equal to the thickness of the material used to form one of the wall plies, and the material is capable of the slight flexure required to place the tabs 150 of the lower enclosure 112 into the slots 152 of the intermediate storage tray 122. It should be understood that the thickness of the materials are exaggerated in FIG. 5 for clarity in the drawing.

However, the lid or cover 130 has peripheral dimensions slightly larger than those of the lower enclosure 112 and the intermediate storage tray 122, as FIG. 5 and a careful examination of FIG. 4 will show. The depending flange or lip 132 of the cover or lid 130 is formed to provide sufficient height, or more correctly depth, to extend downward past the upper edge of the lower enclosure 112, as shown in FIG. 5. The closely fitting flange or lip 132 of the lid or cover 130 around the edge of the lower enclosure 112 assures that the intermediate storage tray 122 cannot be misaligned out of registry with the edges or walls 114 of the lower enclosure when the lid or cover 130 is placed atop the assembly.

Accordingly, it will be seen that the pet accessory 10 or 110 is a versatile means of providing an unobtrusive litter box or hideaway for a pet. The appearance of the device and its ability to be oriented to conceal the pet access opening result in an accessory that may be placed anywhere in the home without attracting undue attention to its purpose. It will be recognized that the pet accessory may be constructed in innumerable other shapes and configurations, e.g., to resemble a kitchen trash container, etc. In addition, as many pets are at least somewhat shy around strangers, the pet accessory 10 or 110 allows those pets to use their litter box or to conceal themselves from strangers present in the home without unduly increasing the level of anxiety of the pet. Accordingly, the pet accessory 10 or 110 will prove to be a valuable addition to households having pets, particularly for pet owners living in relatively small or cramped quarters having no practicable location for concealing a conventional litter box or pet bed.

It is to be understood that the present invention is not limited to the embodiments described above, but encompasses any and all embodiments within the scope of the following claims.

I claim:

1. A pet accessory, comprising:
an enclosure having a sidewall and a pet access opening formed through the sidewall, a closed floor, and an open top;
a litter trap selectively disposed immediately adjacent the pet access opening of the enclosure external thereto;
an intermediate storage tray removably disposed atop the enclosure; and
a lid removably disposed atop the storage tray.

2. The pet accessory according to claim 1 wherein the litter trap has a retaining flange extending outwardly therefrom, the flange being selectively captured beneath the floor of the enclosure.

3. The pet accessory according to claim 1, wherein:
the intermediate storage tray has a plurality of ventilation passages defined therein; and
the lid has a neck having a panel disposed thereacross, the panel having a plurality of ventilation passages defined therein.

4. The pet accessory according to claim 3, further including an odor filter disposed within the neck of the lid immediately above the panel.

5. The pet accessory according to claim 1, wherein the litter trap has a textured surface adapted for the removal of litter from the paws of an animal.

6. The pet accessory according to claim 5, wherein the litter trap has a peripheral wall extending about a majority of the textured surface.

7. The pet accessory according to claim 1, wherein the enclosure has a plurality of ventilation passages defined therein.

8. A pet accessory, comprising:
an enclosure having a sidewall, a pet access opening formed through the sidewall, a closed floor, and an open top; and
a litter trap selectively disposed immediately adjacent the pet access opening of the enclosure external thereto, the litter trap having a retaining flange extending outwardly therefrom, the flange being selectively captured beneath the floor of the enclosure.

9. The pet accessory according to claim 8, further including:
an intermediate storage tray removably disposed atop the enclosure; and
a lid removably disposed atop the storage tray.

10. The pet accessory according to claim 9, wherein:
the intermediate storage tray has a plurality of ventilation passages defined therein; and
the lid has a neck having a panel disposed thereacross, the panel having a plurality of ventilation passages defined therein.

11. The pet accessory according to claim 10, further including an odor filter disposed within the neck of the lid immediately above the panel.

12. The pet accessory according to claim 8, wherein the litter trap has a textured surface adapted for the removal of litter from the paws of an animal.

13. The pet accessory according to claim 8, wherein the litter trap has a peripheral wall extending about a majority of the textured surface.

14. The pet accessory according to claim 8, wherein the enclosure has a plurality of ventilation passages defined therein.

15. A pet accessory, comprising:
an enclosure having a sidewall, a pet access opening formed through the sidewall, a closed floor, and an open top;
an intermediate storage tray removably disposed atop the enclosure, the tray having a plurality of ventilation passages defined therein; and
a lid removably disposed atop the storage tray, the lid having a neck and a panel disposed across the neck, the panel having a plurality of ventilation passages defined therein.

16. The pet accessory according to claim 15 further including a litter trap selectively disposed immediately adjacent the pet access opening of the enclosure external thereto, the litter trap having a retaining flange extending outwardly therefrom, the flange being selectively captured beneath the floor of the enclosure.

17. The pet accessory according to claim 16, wherein the litter trap has a textured surface adapted for the removal of litter from the paws of an animal.

18. The pet accessory according to claim 16, wherein the litter trap has a peripheral wall extending about a majority of the textured surface.

19. The pet accessory according to claim 15, further including an odor filter disposed within the neck of the lid immediately above the panel.

20. The pet accessory according to claim 15, wherein the enclosure has a plurality of ventilation passages defined therein.
